(19) United States
(12) Patent Application Publication
(10) Pub. No.: US 2023/0028895 A1
(43) Pub. Date: Jan. 26, 2023

(54) Hair B&B

(71) Applicant: Antonio Owens, Youngstown, OH (US)

(72) Inventor: Antonio Owens, Youngstown, OH (US)

(21) Appl. No.: 17/384,938

(22) Filed: Jul. 26, 2021

(51) Int. Cl. G06Q 50/16; G06Q 30/06; G06Q 50/18; G06Q 40/02; G06Q 30/02; G06F 16/2455

(52) U.S. Cl. CPC G06Q 50/163; G06Q 30/0645; G06Q 50/188; G06Q 40/025; G06Q 30/0201; G06F 16/2455

(57) ABSTRACT

The present invention is a system and method for conveniently sending and receiving data and a method of reserving workspace. In particular, the invention allows a user to uniquely search for and lease a workspace for providing hair beauty services in a convenient manner. The proposed embodiment provides a unique experience for a user by providing a pleasant and secure experience.

### CROSS-REFERENCE TO RELATED APPLICATIONS

None.

### BACKGROUND OF THE INVENTION

### Field of the Art

The disclosure relates to a system for the hair and beauty industry. The embodiment allows a business owner to facilitate leasing workspace to various third-party hair professionals when necessary.

### Discussion of the State of the Art

The proposed embodiment is further ideal because its' ultimate purpose is to allow network members access to workspace to provide cosmetology services to clients that are not otherwise accessible in a manner that will be a welcoming change for patrons. Most cosmetology professionals do not have access to existing workspace to utilize booths or seats on a as needed basis.

### SUMMARY OF THE INVENTION

Accordingly, the inventor has conceived, in a preferred embodiment of the invention, a system for conveniently providing a method for cosmetology professionals to conveniently lease workspace from a host on an as needed basis for providing salon related services. According to a preferred embodiment of the invention, is a system that is designed to allow cosmetology professionals to use a network to search for workspace in an existing salon and lease the workspace for a period of time in order to provide cosmetology services. Professionals would become network members by using a mobile app or a website. What is further disclosed is a method for members to enter into a short-term lease agreement to effectively serve clients at various locations. Once a network membership has been established and an account has been created then a network member may schedule and book a workspace at their leisure. The remote access to a convenient software system for leasing short-term workspace is a key component of the invention.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary and are not to be considered as limiting of the scope of the invention or the claims herein in any way.

FIG. 1 is a system diagram for an exemplary system configuration consistent with certain embodiments of the present invention.

FIG. 2 is a system diagram for uploading data onto a mobile device consistent with certain embodiments of the present invention.

FIG. 3 is a process flow of critical data for the host or member of a mobile device consistent with certain embodiments of the present invention.

FIG. 4 is a process flow of critical data for the host or member of a mobile device consistent with certain embodiments of the present invention.

### DETAILED DESCRIPTION

The inventor has conceived, a system application that allows members of the Hair B&B™ network to receive and submit data and the like in a convenient manner to create a network of professionals and to lease short-term workspace.

The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an exemplary embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, or characteristics may be combined in any suitable manner in one or more embodiments without limitation.

Reference throughout this document to “electronic term sheet” or similar terms refers to a spreadsheet in electronic form which stores data for assisting parties during lease negotiations. Thus, the appearances of such phrases or in various places throughout this specification are not necessarily all referring to the same embodiment. Furthermore, the particular features, structures, or characteristics may be combined in any suitable manner in one or more embodiments without limitation.

Reference throughout this document to “leasing agreement”, “interface”, or similar terms refers to a system that allows the embodiment to interface with the user while allowing data relating to existing workspaces to be submitted to a mobile device for executing an agreement between parties. Thus, the appearances of such phrases or in various places throughout this specification are not necessarily all referring to the same embodiment. Furthermore, the particular features, structures, or characteristics may be combined in any suitable manner in one or more embodiments without limitation.

Reference throughout this document to “member”, “network members” or similar terms refers to business entities or industry professionals registered in the network. The reference is a description of those who are professionals who is interested in securing a workspace to provide hair and beauty services. Thus, the appearances of such phrases or in various places throughout this specification are not necessarily all referring to the same embodiment.

Reference throughout this document to “host”, “owner”, or similar terms refers to individuals or business entities who are salon owners or other workspaces that provide short-term commercial lease space to members on a as needed basis; daily, weekly, hourly etc. The reference is a description of those who are owners or in a legal position to lease necessary space, booths, or seats to members in order to supply hair and beauty services. Thus, the appearances of such phrases or in various places throughout this specification are not necessarily all referring to the same embodiment.

Reference throughout this document to “agents”, “deal agents”, “site visit agents”, or similar terms are individuals who assist a member with finding a preferred workspace and ultimately help the member complete the leasing transaction. Thus, the appearances of such phrases or in various places throughout this specification are not necessarily all referring to the same embodiment.

Reference throughout this document to “first communication device” or “client computers” refers to a variety of components that operates using any means of internet connection or similar modem that transmits packets of data that allow smart devices (such as phones, tablets, computers, handheld devices, smart watches, game devices, etc.) to be updated when they receive data. The ability of a mobile device to collect such data is important when compiling critical information to relay to the user.

One or more different inventions may be described in the present application. Further, for one or more of the inventions described herein, numerous alternative embodiments may be described; it should be appreciated that these are presented for illustrative purposes only and are not limiting of the invention contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only and are not to be taken as limiting the disclosure in any way.

A description of an embodiment with several components in connection with each other does not imply that all such components are required. To the contrary, a variety of optional components may be described to illustrate a wide variety of possible embodiments of one or more of the inventions and in order to more fully illustrate one or mote aspects of the inventions.

In an embodiment, the Hair B&B™ network system allows “Hosts” (salon owners) to provide booths/seats via a workspace management server that are not being utilized to other industry professionals (members) on a as needed basis; daily, weekly, hourly etc. Hosts will pay a monthly fee for the network and will have the ability to post their shop or salon vacancies (open booths/seats; on the network for “members” to view and reserve workspaces utilizing a leasing software module. Additionally, the network will allow a registered host to advertise products and services on the system to allow other users to purchase directly from the host via an online platform. The network is designed to provide a unique and novel manner for a member to locate space to provide beauty services to potential clients. The system allows a member to have access to a network of existing workspace that is available for lease; the leasing software module is hosted on the workspace management server. The leasing software will populate the lease agreement based on predetermined information gathered from an electronic term sheet. Where a member of the Hair B&B™ network is either away from their home for business purposes and has a potential customer in another city or just need additional space due to business growth; the member may utilize the embodiment to locate a temporary work space. In essence, the member will be able to login to the system by using their credentials and request a workspace. In a non-limiting example, the system can utilize artificial intelligence to assist members in finding the ideal workspace location to provide beauty services based on their predetermined preferences. To elaborate, where a member has certain specializations and requirements as a cosmetology professional, the member may utilize the network that is driven by artificial intelligence to search the network database to locate workspace that fits the required preferences.

Members can register in the distributed computer network by listing their predetermined preferences for workspaces. This would allow the artificial intelligence-based software module to adequately select the type of workspace in the desired location for a member utilizing a characteristics listed in an electronic database. Upon a determination, a message will be submitted to a designated agent to oversee the transaction and the member will be contacted. When a workspace is agreed upon, a lease agreement will be drafted and submitted to the member to review. If there are any revisions which need to be made, the host, network member, and or the agent can make such revisions and resubmit the agreement for review and signature.

Specific details are given in the following drawings to provide a thorough understanding of the embodiments. However, it will be understood by one of ordinary skill in the an that the embodiments may be practiced without these specific details. For example, systems, networks, processes, and other components may be shown as components in block diagram form in order not to obscure the embodiments in unnecessary detail. In other instances, well-known processes and techniques may be shown without unnecessary detail to avoid obscuring the embodiments.

### EXEMPLARY EMBODIMENTS

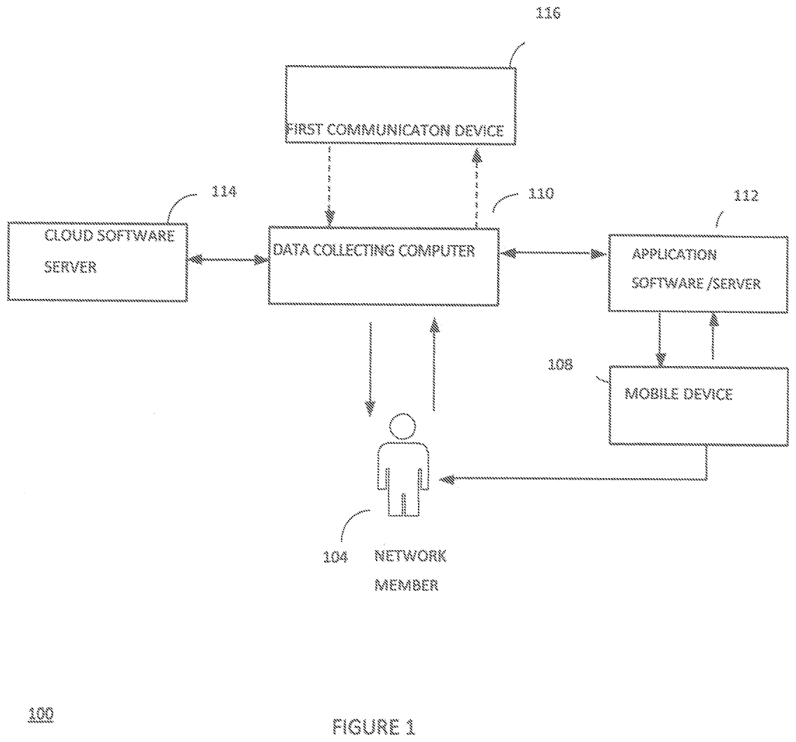

FIG. 1 illustrates a network implementation of the present artificial intelligence-based system 100 to provide leasing assistance to members over a network, in accordance with an embodiment of the present subject matter. Although the present subject matter is explained considering that the present artificial intelligence-based system 100 is implemented on a workspace management server “server” 102, it may be understood that the present artificial intelligence-based system 100 may also be implemented in a variety of computing devices, such as a laptop computer, a desktop computer, a notebook, a workstation, a mainframe computer, a server, a network server, and the like. It will be understood that the present artificial intelligence-based system 100 may be accessed by multiple users through one or more computing devices, collectively referred to as computing device 112 hereinafter, or applications residing on the computing device 112. Examples of the computing device 112 may include but are not limited to, a portable computer, a personal digital assistant, a handheld or mobile device, smart devices, and a workstation. The computing devices 112 are communicatively accessible to the present artificial intelligence system 100 through a network 106.

In one implementation, the network 106 may be a wireless network, a wired network, or a combination thereof. The network 106 can be implemented as one of the different types of networks, such as an intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

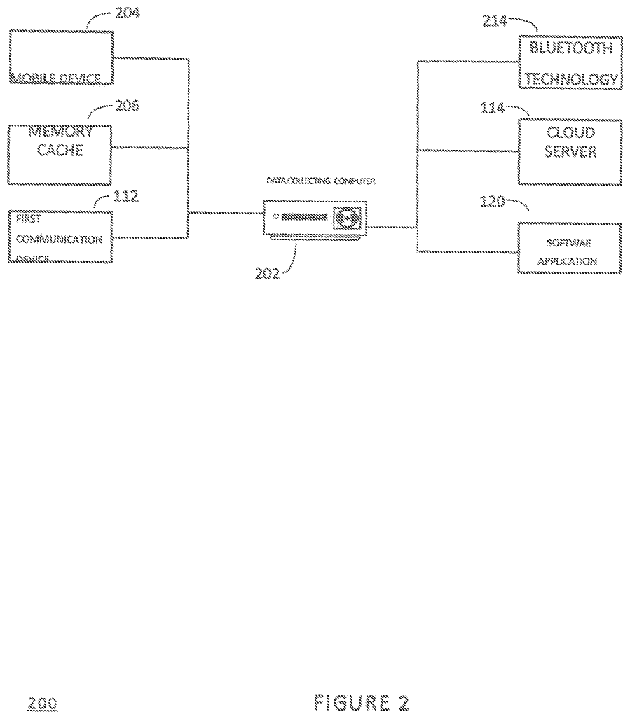

Turning to FIG. 2, this figure presents an artificial intelligence-based system diagram for an exemplary system configuration for leasing available workspace consistent with certain embodiments of the present invention. FIG. 2 is explained in conjunction with FIG. 1. This figure presents a diagram for how a mobile device 204 captures data and stores memory in a cache 206 which continuously collects data from users to create an electronic term sheet. The collected data is submitted to a memory cache 206 and is maintained by the server 114. The memory cache 206 is an active component of a data collecting computer 202 that communicates with the first communication device 112 that stores data for a designated contact. Each mobile device 204 may have multiple applications installed on the device 204 based upon preferences. The installed software application 218 to each mobile device 204 is connected to the data collecting for purposes of transmitting specification data to the first communication device 112. The applications 218 do not have to be active for the server 114 to retrieve data, but the device must be operational and manually initiated by the user in order to collect data such as the size and number of booths required in a workspace. The system may retrieve the information for the user and transmit tine collected data for the mobile device 204, and information stored for the owner or user of the mobile device 204 to retrieve at a later date. In an embodiment, the mobile application 120 receives data thorn the server 102 which acts as a database as well to allow the members and hosts to track the activity data. The data includes real-time information regarding specifications of the requested workspace. The database includes a multi-list of information for users to serve as an informational platform to allow for various selections/screens. This platform allows users to send/receive alerts and monitor the available spaces.

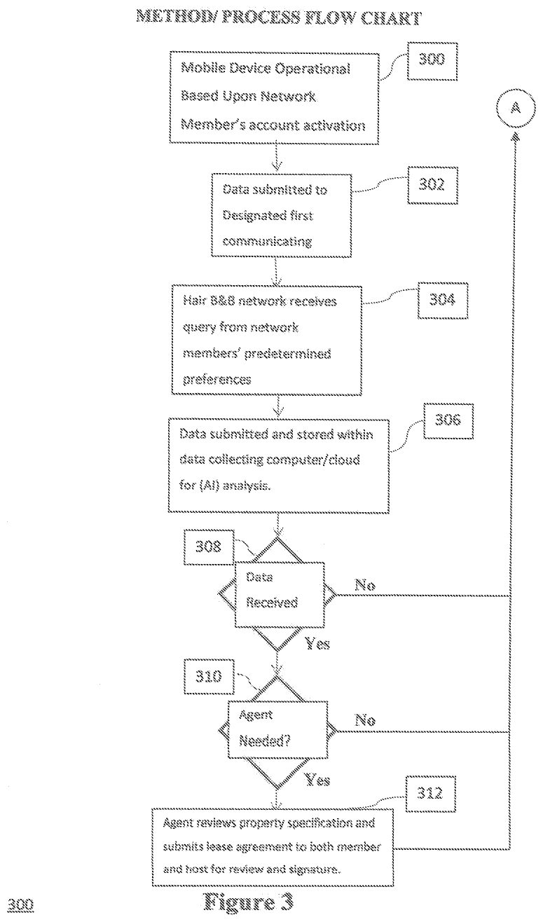

FIG. 3 illustrates a flowchart 300 of the artificial intelligence-based method for a network, in accordance with at least one embodiment. The artificial intelligence-based method includes a step 302 of capturing, by one or more processors, activity data of the member in real-time through a capture module. The artificial intelligence-based method includes a step 304 of analyzing, by one or more processors, the activity data received from the capture module to assign a quantitative value corresponding to each of the activity data through an analysis module. The artificial intelligence (AI) based method includes a step 306 of transmitting, by one or more processors, the activity data analyzed by the analysis module to a computing device through a transmission module. The artificial intelligence-based method includes a step 308 of presenting, by one or more processors, the activity data through the computing device.

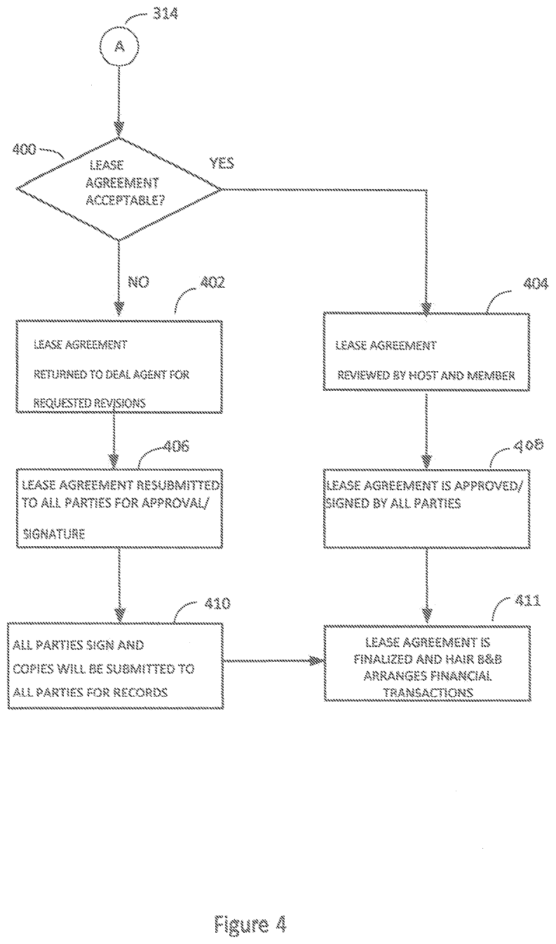

FIG. 4 illustrates a flowchart 400 of the artificial intelligence-based method for a network, in accordance with at least one embodiment. FIG. 4 is explained in conjunction with FIG. 3. The artificial intelligence-based method of step 314 includes a decision step 400 for determining whether or not a lease agreement is acceptable; at step 404, if the lease agreement is acceptable then the agreement will be transmitted electronically to the host and member for review; at step 408, the lease will be approved/signed by all parties; at step 402, if the lease agreement is not acceptable then the agreement will be returned to the agent for requested revisions; at step 406, once the revisions have been completed then the agreement will be resubmitted to all parties for approval; at step 408, once all parties have signed then finalized copies will be submitted to all parties for their records; at step 411, the lease process will be finalized and financial transactions will be arranged.

Thus, the embodiment and method provide an efficient, simpler, and more elegant framework for searching and selecting workspaces in real-time. Further, the present artificial intelligence-based system and method provide an automated activity monitoring system that not only tracks available workspaces, but that also has robust means for advertising products. The present embodiment can monitor and create a social media platform where products can be sold by hosts.

While embodiments of the present disclosure have been illustrated and described, it will be clear that the disclosure is not limited to these embodiments only. Numerous modifications, changes, variations, substitutions, and equivalents will be apparent to those skilled in the art, without departing from the scope of the disclosure, as described in the claims.

What is claimed is:

1. A system for enabling a lease transaction for workspace using on-line computing, comprising:
a workspace management server hosting a leasing software module for enabling the lease transaction;
at least one database, coupled to said workspace management server, storing workspace-related data for a plurality of client computers coupled to said workspace management server, at least one client computer operable by a host and at least one client computer operable by a member, wherein the host and the member input predetermined information about a selected workspace into said leasing software module and negotiate an electronic term sheet using said leasing software module in support of the lease transaction for the selected workspace, wherein said leasing software module accesses the workspace data on one of said at least one database to obtain data relevant to the selected workspace, populates a lease agreement based on information from a host of the selected workspace and information in the electronic term sheet negotiated by the host and the member, and presents the populated lease agreement and the member, and the comparable data for approval by the host and the member;
an artificial intelligence-based software module for leasing a workspace comprising:
capturing, by one or more processors, activity data of the member in real-time through a capture module, analyzing, by one or more processors, the activity data received from the capture module to assign a quantitative value corresponding to each of the activity data through an analysis module,
transmitting, by one or more processors, the activity data analyzed by the analysis module to a computing device through an analysis module; and presenting, by one or more processors, the activity data through the computing device.

2. The system of claim 1, wherein said client computers comprise one or more of a lender client computer operable by a lender to support workspace financing requirements for the selected workspace;
a site visit agent computer operable by a site visit agent to support on-site workspace review and analysis of the selected workspace;
a workspace specialist client computer operable by a workspace specialist to provide workspace-related expertise in connection with the selected workspace; and a deal agent client computer operable by a deal agent to screen, negotiate, and close workspace transactions in connection with the selected workspace.

3. The system of claim 2, wherein the property specialist computer is operable by a property specialist comprising one of a workspace-specialist and a workspace technician.

4. The system of claim 2, wherein said client computers further comprise a call center client computer operable by a call center agent, and wherein the member can select a user operating another one of the client computers by contacting the call center agent.

5. The system of claim 1, wherein said at least one database comprises a local database maintained by a party responsible for said workspace management server.

6. The system of claim 1, wherein said at least one database comprises a remote database maintained by a party other than a party responsible for said workspace management server.

7. The system of claim 1, wherein said workspace management server is operable to store information about a plurality of site visit agents that support on-site property review and analysis of the selected workspace, and wherein a member can select one of the site visit agents from the information stored on the workspace management server to support the lease transaction.

8. The system of claim 1, wherein said workspace management server is operable to store information about a plurality of deal agents that screen, negotiate, and close workspace-related transactions, and wherein a member can select one of the deal agents from the information stored on the workspace management server to support the lease transaction.

9. The system of claim 1, wherein said workspace management server is operable to store information about a plurality of workspace specialists that provide workspace-related expertise in connection with the selected workspace, and wherein a member can select one of the workspace specialists from the information stored by the workspace specialists from the information stored on the workspace management server to support the lease transaction.

10. A computer implemented method for conducting a lease transaction for workspace in a distributed computer network environment, comprising the steps of:
storing workspace characteristics from an electronic database; defining a member's property requirements for leasing a workspace using an artificial intelligence based software module operating on a workspaces services server; identifying with the artificial intelligence based software module a matching workspace from one of the host's workspace listing, the matching workspace comprising characteristics from the host that match the member's workspace requirements; publishing with the artificial intelligence based software module the matching workspace that matches the member's workspace requirements; storing in the electronic database an electronic term sheet negotiated by the host and the member using the artificial intelligence based software module operating on the workspace services server; creating a lease agreement for the matching workspace by populating the characteristics from the host for the matching workspace and the terms of the electronic term sheet into a form lease agreement comprising lease terms and legal provisions; and publishing the created lease agreement for review by the member and the host.

11. The method of claim 10, further comprising the steps of:
allowing the member and the host to revise the lease agreement via the distributed computer network; and allowing the member and the host to execute the lease agreement via the distributed computer network.

12. The method of claim 10, further comprising the steps of:
allowing the member to make an offer via the distributed computer network to lease the matching host workspace;
allowing the host of the matching host workspace to accept the offer via the distributed computer network; and
allowing the member and the host to modify the offer via the distributed computer network.

13. The method of claim 10, wherein said host workspace characteristics are stored in a plurality of remote databases maintained by one or more third parties.

14. The method of claim 10, further comprising the steps of:
storing information for a plurality of deal agents that screen, negotiate, and close workspace-related transactions;
and selecting, based on the stored information, one of the deal agents via the distributed computer network to support the lease agreement for the matching host workspace.

15. The method as claimed in claim 10, wherein the artificial intelligence software includes one or more of: workspace data, member customer data, social media data, physical address data, and financial data.
